(19) United States
(12) Patent Application Publication
(10) Pub. No.: US 2014/0263009 A1
(43) Pub. Date: Sep. 18, 2014

(54) LOW WATER FOOTPRINT RE-CIRCULATING AQUATIC SYSTEM FOR THE SUSTAINABLE CULTIVATION OF AQUATIC ORGANISMS AND PLANTS

(71) Applicant: University of North Texas, Denton, TX (US)

(72) Inventors: Ione Hunt von Herbing, Denton, TX (US); Michael Anderson, Denton, TX (US)

(73) Assignee: University of North Texas, Denton, TX (US)

(21) Appl. No.: 14/200,981

(22) Filed: Mar. 7, 2014

Related U.S. Application Data
(60) Provisional application No. 61/783,816, filed on Mar. 14, 2013.

(51) Int. Cl. A01K 63/04

(52) U.S. Cl. CPC A01K 63/045
USPC 210/195.1; 210/335; 210/290

(57) ABSTRACT

A sustainable Low Water Footprint Re-circulating Aquatic System for cultivating aquatic organisms and plants. The system conserves water and energy by using gravity to move water and nutrients from the clarifier into the low water footprint management system. The novel water management system controls the volume of water in the plant grow bed such that it never rises to or above the surface, limiting evaporative water loss. Water flow to the plant grow bed is intermittent and the water management system retains water within the grow bed by capillary action, even when there is no water input. The grow bed contains microflora that convert nitrogenous wastes produced by the aquatic organisms to nitrogenous compounds useable by the plants. The clarified water is then pumped back into the animal tanks. The system is sustainable, cost effective, and highly productive, and uses 50-80% less water than conventional re-circulating aquatic production system.

This application claims the benefit of U.S. Provisional Patent Application Ser. No. 61/783,816, entitled LOW WATER FOOTPRINT RE-CIRCULATING AQUATIC SYSTEM FOR THE SUSTAINABLE CULTIVATION OF AQUATIC ORGANISMS AND PLANTS filed on Mar. 14, 2013, the entire content of which is hereby incorporated by reference.

### BACKGROUND

The present invention relates to a method and apparatus for aquaponic farming and more specifically to a Low Water Footprint Re-circulating Aquatic System.

Aquaponic farming dates back to the Aztecs, and indigenous floating systems were also widely used under the name of chinampas in Mexico, kaing in Burma, tonle sap in Cambodia and were said to be very productive (Pantanella et al., 2010). Modern aquaponics or Re-circulating Aquaculture Systems (RAS) (also referred to as integrated farming) are designed to raise large quantities of fish in relatively small volumes of water by treating the fish liquid (ammonia) and solid (fecal matter) organic wastes through a microbial filter (grow bed) which converts the waste (ammonia) into nitrites and then nitrates, which ultimately serve as plant nutrients. The nitrates are taken up by the plants and are thereby channeled into secondary crops/plants, which use these microbial modified fish by-products to grow. The water in the grow bed is in turn filtered of nitrogenous waste products and returned to the fish in a re-circulating/closed system.

Existing Aquaponics Demonstration Systems: The most common aquaponic systems are raft systems pioneered by the University of the Virgin Islands, which has a long-running demonstration aquaponics system producing about 20,000 lbs. of tilapia annually, and various vegetables that are sold commercially (Rakocy et al. 1997). However, Aquaponics enterprises in the U.S. are still few in number; two of the best examples of successful aquaponics businesses are S & S Aqua Farm in Missouri and Bioshelters in Massachusetts.

There are several types of conventional aquaponics systems, but most are either reciprocating or constant-flow systems. A reciprocating system is one in which the hydroponic media are alternatively flooded and then drained on a regular basis (every 30 min.), usually with the plant roots in a granular or fibrous media (e.g. sand, vermiculite, perlite, or coconut husk fiber). A constant flow system is one in which the roots are always immersed in the nutrient solution, which flows at a constant rate of 24 hours a day. These systems can use some kind of solid soilless media, but the roots can also hang freely in the solution. Examples include the raft (Rakocy et al., 2007) and nutrient film systems (where the plants are positioned in floating foam or cork rafts and their roots are submerged in the flowing solution) and the trickling bed system (Tyson et al., 2007, Tyson et al., 2008). While the reciprocating systems use less total water than constant flow systems, large volumes are still need for system establishment.

All existing aquaponics and hydroponics technologies involve placing the root of the plant into a water flow, a water reservoir, or a growing medium that is periodically flooded and drained. The Low Water Footprint Re-circulating Aquatic System of the present invention will provide for establishment of a growing medium that is more akin to what occurs naturally, while still providing all the benefits of the nutrient cycling of a Re-circulating Aquaculture System (RAS). Further, a reduction in plant disease, pests, or mechanical disruption will enhance production.

Re-circulating aquaculture systems typically present water management and conservation problems, because they require a great deal of water for inception of operation. The present invention addresses these issues by providing a novel Low Water Footprint Re-circulating Aquatic System which uses 50-80% less water compared with existing re-circulating aquaculture systems.

The novel technology of the Low Water Footprint Re-circulating Aquatic System of the present invention satisfies the USDA Strategic Goal 1: Assist rural communities to create prosperity so they are self-sustaining, repopulating and economically thriving. Opportunities for innovation in agriculture knowledge, science and technology are needed to increase food security and safety. The proposed novel technology serves to diversify diets and improve micronutrient intake improving human health, nutrition and livelihoods. In fostering water conservation and food security, commercialization of the Low Water Footprint Re-circulating Aquatic System technology may aid the world's hungry while supporting the multifunctionality of agriculture. Multifunctionality recognizes agriculture as a multi-output activity producing not only commodities (food, feed, fibers, agrofuels, medicinal products and ornamentals), but also non-commodity outputs such as environmental services, landscape amenities and cultural heritages. Advances in aquaponics science can enhance sustainable agriculture productivity, address small-scale farmer needs in diverse ecosystems and create opportunities for development where the potential for improved area productivity is low and effects of climate change severe.

### SUMMARY

The present invention provides a sustainable Low Water Footprint Re-circulating Aquatic System for cultivating aquatic organisms and plants, comprising:
a) an animal tank system for containing aquatic organisms;
b) an external pump;
c) a non-mechanical three-stage clarifier system which receives water from the external pump and which separates liquid nitrogenous wastes from solid wastes;
d) a liquid waste water holding tank;
e) an overflow, such that after water passes through the three-stage clarifier into the holding tank, any remaining solids can settle as the water fills up to the top of the stand pipe, where it overflows and continues on toward toward the growbeds;
f) a three way valve manifold;
g) a plant grow bed, which receives liquid waste water from the three way valve manifold;
h) low water footprint ‘restriction flow’ management system contained within the plant grow bed, which together with the microflora and plants in the grow bed filters the liquid waste water to return it to the animal tank.

The Low Water Footprint Re-circulating Aquatic System of the present invention is advantageous over conventional technology because of its potential for water management and conservation.

The present invention presents a unique method of managing water flow within a re-circulating aquatic system. In some embodiments, only one pump is used, thereby reducing energy use as gravity moves water and nutrients from the clarifier into the water management system. Some embodiments employ a novel low water footprint water management system which controls the volume of water in the plant grow bed such that it never rises to or above the surface, limiting evaporative water loss. Water flow to the plant grow bed is intermittent and the low water footprint management system retains water within the grow bed by capillary action, even when there is no water input.

The plants in some embodiments of the invention act as an organic filtration system. The grow bed contains microflora that convert nitrogenous wastes produced by the aquatic organisms to nitrogenous compounds useable to the plants.

In embodiments of the invention, the clarified water from the plant grow bed is pumped back into the animal tank.

The primary aim of the present invention is to develop a Re-circulating Low Water Footprint Aquatic System, that is sustainable, cost effective, and highly productive, but which uses 50-80% less water than any other re-circulating aquatic production system.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a basic schematic of the Low Water Footprint Re-circulating Aquatic System in an embodiment of the present invention.

FIG. 2 shows a multi-stage aquaponics system clarifier in an embodiment of the present invention. In this embodiment, the clarifier has three levels of filtration, and utilizes a design shell which is easy to open and clean. This allows for limited downtime of the aquaponics system. In this embodiment, the waste water is pumped into a basket collection that will have a fine screening on the lower half and a less dense screening on the upper half. The bottom of the housing canister comprises a final clarifier stage where the water passes through a fine 25 micron filter material before the remaining water passes into the primary holding tank of the aquaponics system as a whole. In this embodiment, the level of debris is easy to monitor through the clear canister and the system is easy to clean.

FIG. 3 shows a low water footprint management and conservation system in an embodiment of the present invention.

FIG. 4 shows: a) a farm scale Low Water Footprint Re-circulating Aquatic System; and b) a mobile/compact closed system aquaponics set up, in embodiments of the present invention.

FIG. 5 shows a mobile/compact closed system aquaponics set-up, in an embodiment of the present invention.

### DETAILED DESCRIPTION

The present invention provides a Low Water Footprint Re-circulating Aquatic System for cultivating aquatic organisms, such as fish, which provide nutrients to plants. The plants act as organic filters, such that a sustainable, cost effective and highly productive food system, which uses 50-80% less water than any other re-circulating aquatic production system is offered to the public and/or commercial development.

### Low Water Footprint Re-Circulating Aquatic System

The present invention provides a Low Water Footprint Re-circulating Aquatic System which provides several novel and inventive features compared to traditional aquaponics and/or re-circulating aquatic systems. Hydroponic plant grow beds are replaced by a specific combination of pea gravel and sand, into which the novel water management system is placed. This water management system allows the Low Water Footprint Re-circulating Aquatic System to conserve water usage by 50-80% compared to other presently existing commercial scale aquaponics/re-circulating aquatic and agricultural systems.

For example, a water footprint for producing US$100 worth of cotton grown in modern agricultural systems used 470,000 liters of water compared to only 173 liters of water for an integrated production of US$100 worth of fish and basil (Dersery, 2010). The Low Water Footprint Re-circulating Aquatic System of the present invention would use an estimated 34.5 to 86.5 liters of water for the same amount of production, potentially saving 50-80% water usage.

In some embodiments of the present invention, the Low Water Footprint Re-circulating Aquatic System comprises a low water footprint management system, which underlies the water conservation and regulates water levels in the plant grow beds. The low water footprint management system prevents water from remaining at the surface of the plant grow bed, thereby significantly reducing evaporative loss. Water is lost primarily through plant evapo-transporation from the plant leaves and stems and very little is lost through evaporation. The process is completely organic and sustainable, and the system is potentially fully scalable from the small-scale family farm to large commercial production farms. Significantly, antibiotics or insecticides are not needed and water use and land use efficiency is increased.

In some embodiments, the Low Water Footprint Re-circulating Aquatic System (FIG. 1) comprises an animal tank system (101) for containing aquatic organisms (e.g. fish) and an external pump (102) connected to a non-mechanical clarifier system (103), which separates liquid from solid wastes, and a low water footprint management system (108) contained within a plant grow bed (107). Inclusion of the low water footprint management system in a re-circulating aquatic system reduces the water footprint by 50-80% compared to non-modified re-circulating aquatic systems.

In some embodiments, the Low Water Footprint Re-circulating Aquatic System comprises an animal tank (101) is made of fiberglass or any material suitable to hold fish or living aquatic animals. The animal tank is on the order of hundreds of gallons, preferably greater than 500 gallons. Nitrogenous liquid and solid waste products are produced the animals in the tank, and the solid waste products settle on the bottom of the tank and need to be removed.

The external pump (102) moves the solid waste from the bottom of the aquatic animal tank. The solid waste and the liquid waste containing ammonia, is moved to the three-phase clarifier (103).

In some embodiments, the Low Water Footprint Re-circulating Aquatic System comprises a three-phase clarifier (103). The three-phase clarifier (103) separates the liquid from the solid wastes (FIG. 2). The clarifier is a container (e.g. one to two liters) that receives water from the fish tank with large amounts of solid and liquid waste. The clarifier is designed with three levels of containment, as follows:
First stage—water containing liquid and solid wastes runs through a screen with a large (e.g. 2 to 3 mm) mesh size. The largest solid waste particles are retained at this stage.
Second stage—The partially filtered water moves through to a second stage where a second smaller filter (e.g. 1 to 2 mm) mesh size removes the remaining medium to large sized particles.
Third-stage—At the final or third phase of filtration the water moves through a fine pore (e.g. 25 to 50 μm) mesh filter, which removes the remaining solid waste particles.

The entire three-phase clarifier unit can be removed for cleaning without interrupting the re-circulating system. The two larger screens (stage 1 & stage 2) can be easily removed and cleaned with water, and are designed to be reused repeatedly. The fine mesh screen in the third stage that traps the finest particles is not reusable, but is easily replaced.

The housing of the three-phase clarifier is clear food-grade Plexiglas, which allows the user to see when the clarifier is full, and also to determine the efficiency of the clarifier.

The three-stage clarifier only permits the liquid nitrogenous waste products to flow into the holding tank. The solid wastes that are collected can be mixed with composting material and used as an entirely organic plant fertilizer.

In some embodiments, the Low Water Footprint Re-circulating Aquatic System of the present invention comprises a holding tank (104), which collects the liquid waste, passing through the clarifier while the solid wastes are retained in the clarifier. The holding tank may be approximately 80-100 gallons in size. Continual addition of water containing nitrogenous liquid wastes from the aquatic animal tank fills the holding tank until the level reaches the overflow.

In some embodiments, the Low Water Footprint Re-circulating Aquatic System of the present invention comprises an overflow valve (105), positioned above the top of the holding tank, which receives the water as it rises and overflows. The overflow valve may be positioned approximately 6 inches above the top of the holding tank. The overflow water containing the liquid wastes is gravity fed to a three way valve manifold (106).

In some embodiments, the Low Water Footprint Re-circulating Aquatic System of the present invention comprises a three-way valve manifold (106) which receives gravity fed water containing the liquid waste from the overflow tank. The manifold is regulated manually or automatically, and functions as an advent flow system. The three way valve manifold regulates and directs the water flow from the overflow into a plant grow bed (107).

In some embodiments, the Low Water Footprint Re-circulating Aquatic System of the present invention comprises one or more plant grow beds (107). The plant grow bed contains pea gravel and sand and microflora that convert ammonia into nitrites and nitrates through denitrification and nitrification. The gravel and sand allow for capillary rise of the nutrient rich water to the plant roots. Water flow through the plant grow bed begins from the bottom of the grow bed and rises upward to just short of the surface of the grow bed. The pattern of water flow is regulated by a low water footprint management system that is installed within each plant grow bed.

In some embodiments, the Low Water Footprint Re-circulating Aquatic System of the present invention comprises a low water footprint management system (108, FIG. 3). The low water footprint management system receives water containing liquid wastes and regulates water flow throughout the grow bed.

The low water footprint management system is made of sections of tough corrugated plastic or suitable materials that can withstand several pounds of gravel and sand without collapsing. It may be a dome or have a semi-circular cylindrical shape.

The low water footprint management system functions to regulate water within the grow bed. Water containing the liquid wastes enters from the holding tank (104) into the water management system (108) through a piped access hole. Water rises from the bottom to the top of the cylinder of the low water footprint management system and completely fills the system. Water rises until it encounters internal circular openings, (several of which run along the inside of one side of the cylinder). The internal openings are staggered and are higher than the external openings and water flow is regulated in a reverse-flow restriction manner and flows out into the plant grow bed.

The flow rate of the water leaving the low water footprint management system is slower than that of the water entering the system (referred to as restriction flow) resulting in water being retained within the system, and providing a constant slow flow to the plant grow bed.

Irrigation of the grow bed (107) occurs in an on-flow and off-flow manner, which can vary in length (e.g. 12 hours on and 48 hours off). Water conservation occurs because the low water footprint management system is intermittent. During the off-flow period the water management system can hold about 30 gallons of water, constantly supplying the plant grow bed with water to irrigate the plant roots, but never allowing the water to rise above the surface of the grow bed, which would result in added evaporation and water loss. Retention of water within the grow bed is facilitated by the row of holes at the bottom water management chamber, which controls how water flows and is distributed throughout the chamber.

In some embodiments, the Low Water Footprint Re-circulating Aquatic System of the present invention comprises a water return (109). After moving through the plant grow bed the water which is now filtered of all nitrogenous liquid and solid wastes returns to the aquatic animal tank via a pipe using gravity.

The Low Water Footprint Re-circulating Aquatic System of the present invention can be tailored to suit any farm or urban installation.

### Advantages of the Low Water Footprint Re-Circulating Aquatic System

Production of high quality sustainable organic produce and water conservation addresses the primary societal challenge of global food security and hunger. The 2009 Executive Summary of “Agriculture at a Crossroads” published by International Assessment of Agricultural Knowledge, Science and Technology for Development, defined food security as “a situation that exists when all people, at all times, have physical, social and economic access to sufficient, safe and nutritious food that meets their dietary needs and food preferences for an active and healthy life. (FA0, The State of Food Insecurity, 2001). The Low Water Footprint Re-circulating Aquatic System serves vulnerable populations in rural or developing areas throughout the world by providing significant return on investment in less than one year.

Advantages of the Low Water Footprint Re-circulating Aquatic System of the present invention include: recovery of dissolved wastes by the plants, reduced environmental discharge, extending water use and minimizing exchange and reducing costs of operation in arid climates or heated greenhouses where water is a significant expense. A secondary plant crop improves a system's profit potential and daily feeding of fish provide a supply of nutrients to the plants and eliminates the need to discharge and replace or adjust depleted nutrient solutions as in hydroponics. The plants remove nutrients from the culture water and eliminate the need for separate and expensive biofilters.

Less Water Monitoring: The low water footprint re-circulating aquatic system of the present invention requires significantly less water quality monitoring than separate hydroponic or re-circulating aquaculture systems. Operational and infrastructure costs such as pumps, reservoirs, heaters and alarm systems can be shared, and the system requires less land than ponds and gardens.

Water Replacement Rates: By reducing water usage by 50-80%, the low water footprint re-circulating aquatic system of the present invention is estimated to have replacement rates of approximately 0.3% to 0.5% of the entire water volume per day. In contrast, a raft system such as the one at the University of Virgin Islands takes a large amount water volumes (2600 gallons per each aquaponics system) to establish, with a mean daily replacement rate of 1.5%-2.4%, i.e. 390-624 gallons).

Significant Reduction of Water Usage and Loss: Given the action of the capillary rise used in the present invention, water levels can be controlled to rise to the level of the top of the sand, but not higher. Water loss is limited to plant transpiration and minimal losses are due to evaporation. Water loss is significantly reduced (by 50-80%) as was shown in the prototype system (see below). Compared to the raft aquaponics systems (Rakocy et al., 1997) and ebb and flow aquaponics systems the low water footprint re-circulating aquatic system of the present invention requires 50%-80% less water to function and also requires 50% to 80% less water replacement compared to previous aquaponics systems.

### EXAMPLE 1

### Farm Application

The Low Water Footprint Re-circulating Aquatic System of the present invention can be modified for use in any land form or urban aquaculture facility in the US or abroad. The Low Water Footprint Re-circulating Aquatic System offers many advantages, including: 1) antibiotics, insecticides, herbicides or fungicides need not be used; 2) the system can be tailored to marginal land; and 3) the system offers a potential high crop yield. The low water footprint re-circulating aquatic system is distinguished by the implementation of novel technology that results in a low water footprint and uses 50-80% less water than other aquaponics/re-circulating aquatic systems and hydroponics systems.

FIG. 4 shows a farm scale low water footprint re-circulating aquatic system with eighteen low water footprint management systems installed in each of two excavated grow beds.

FIG. 4a shows an exemplary system with an agricultural portion and a tilapia-growing portion. The agricultural portion comprises a bed overflow (1), and a catch basin for filtered water from the grow bed overflow (2). Return plumbing (3) allows for water to be pumped back to fish tanks, accomplishing recirculation of naturally filtered water.

Manual or automated on/off valves (4) on each of the outflow lines to the two grow bed systems allow for control by the water management system. Specified alternative variable flow systems can be provided, such that each grow-bed contains a functional low water management system with active capillary rise.

Plumbing (5) from the three-part clarifier carries nutrient-rich water from the three-part clarifiers (6). The three-part clarifier is installed with on/off valves so that multiple clarifiers can be alternated, allowing them to be cleaned without shutting down the system.

Water from the animal tanks (7) is transported to a three-part clarifier, which removes solid material and allows nutrient rich water to continue to the grow beds.

The tilapia-growing portion comprises shut-off valves (8) at the end of each line of tanks to be able to regulate flow if needed on the outflow lines. Return flow lines (509) supply clean water for each of the rearing tanks where the fish are raised.

FIG. 4b shows an animal tank for raising tilapia. The animal tank is made of commercial plastic, and is fitted with a center drain and a screened dome drain cover to protect the fish from being sucked into the drain process. The figure shows a roof over a grow bed system, a side view of a tank with a stand to raise the tank such that the plumbing system can be installed beneath, and a cross-sectional view of a grow bed. An exemplary tank is approximately 7-9 feet across and approximately 28 to 32 inches high, and an exemplary roof is 30′×100′ with 10′ sidewalls, constructed of clear corrugated roofing. The grow bed cross section shows how the low water footprint management system is located on the bottom of the tank, sealed against the bottom by weight from the gravel and sand on top. In the exemplary system shown in the figure, two and a half inches of pea gravel are used, followed by 11 inches of sand. In a non-limiting example, the pea gravel may be approximately 2.5 to 3.5 inches, and the sand approximately 11 to 13 inches.

### EXAMPLE 2

The Low Water Footprint Re-circulating Aquatic System of the present invention can be a mobile unit. FIG. 5 shows an exemplary mobile low water footprint re-circulating aquatic system, which could be used in developing countries or anywhere aquaculture would be beneficial.

The figure shows three plant grow beds in this smaller scale design. The grow beds are fed with nutrient rich water (in this case derived from the fish tank in an advent/intermittent flow design). Each grow bed receives 12 hours of nutrient rich water flow, and 48 hours of no water flow. The water flows into the corrugated low water management chambers that regulate the amount of water released into the grow bed medium, feeding the plants roots from below the surface of the grow bed. The water is regulated through the reverse flow restriction into the pea gravel medium that is 2½ inch's deep. This allows the water to spread out throughout the grow bed basin. The sand medium draws the water up through the process of capillary rise. The sand draws the nutrient rich water up to predictable level within the grow bed such that plant roots can utilize the water and microbial modified nutrients. Principles of cohesion and adhesion of the water and sand medium facilitate the process. The grow bed is designed with an overflow concept that allows the water that has been filtered to return clean water back to the primary aquatic animal tank (using gravity).

The Mobile Low Water Footprint Re-circulating Aquatic System is designed so that the grow bed purifies the water naturally while conserving water, without the need for energy expensive mechanical filtration. This compact system will be able to be set up in many locations, is simple to use with minimal training.

### EXAMPLE 3

A small experimental Low Water Footprint Re-circulating Aquatic System was constructed to test the viability of this novel aquaponics system. Stabilization of the system took only two months and plant and vegetable growth began within three months.

Maturation of the microbial grow bed was 50% faster than any other existing system. Research is continuing to determine the reasons underlying the high productivity.

Daily replenishment of the water was estimated to be between 0.3 to 0.5% of the whole volume of the system.

Plants that were grown in the prototype systems are as follows: Tomato (two different varieties, six total per system), Genovese Basil (around 20 to 30 per system), Genovese Parsley (around 20 to 30 per system), King of the North Bell Pepper (three to six per system), Pepperoncini Italian (three to six per system), Italian Oregano (20 to 30 per system), and Garlic Chives (20 to 30 per system). All were grown as seedlings for 4 to 8 weeks and then transplanted into the system.

### REFERENCES CITED

The following references, to the extent that they provide exemplary procedural or other details supplementary to those set forth herein, are specifically incorporated herein by reference.

### Non-Patent Literature

De Dersery, A. S. (2010). Commercial Integrated Farming of Aquaculture and Horticulture. International Special Skills Institute, Melbourne, Australia.
El-Shafai S A, El-Gohary F A, Nasr F A, & N P van der Steen (2004). Chronic ammonia toxicity to duckweed-fed tilapia Orechromis niloticus. Aquaculture 232:117-127.
Gleeson T., Wada Y, Bierkens, M F P., & van Beek L P H. (2012) Water balance of global aquifers revealed by groundwater footprint. Nature 488: 197-200.

Pantanella E, Cardarelli M, Colla G, Rea E, & A. Marcucci (2012). Aquaponics vs. hydroponics: Production and quality of lettuce crop. Acta Horticulturae (ISHS) #927. XXVIII International Horticultural Congress on Science and Horticulture for People (IHC2010): International Symposium on Greenhouse 2010 and Soilless Cultivation. May 2012. Lisbon, Portugal.

Rakocy J E (2002) Aquaponics: vegetable hydroponics in re-circulating systems. In Timmons M B, Ebeling J M, Wheaton F W, Summerfedt S D & B J Vince eds. Re-circulating Aquaculture Systems, 2^{nd} Edition, North Eastern Regional Aquaculture Center.
Rakocy J E, Bailey D S, Schultz K A & Cole W M (1997), Evaluation of a commercial-scale aquaponic unit for the production of Tilapia and lettuce. In, Fitzsimmons K, (Ed.). Tilapia Aquaculture: Proceedings of the Fourth International Symposium on Tilapia in Aquaculture, Orlando, Fla., pp. 392-394.
Rakocy, J E. (2007). Ten guidelines for aquaponic systems. Aquaponics Journal 46:14-17.
Savidov, N. (2004) Evaluation and Development of Aquaponics Production and Product Market Capabilities in Alberta. Ids Initiative Fund Final Report. Project #679056201. Aug. 17, 2004.
Savidov, N. (2005). Evaluation and Development of Aquaponics Production and Product Market Capabilities in Alberta. Phase II. New Initiatives Fund—2004-2005, Final Report—Project #2004-679056201, Dec. 20, 2005.
Timmons, M B & J M Ebeling (2002). Re-circulating Aquaculture Systems (3^{rd} Edition). Landau Press, pps. 440.
Tyson R V, Simonne E H 2008 & D D Treadwell (2008) Reconciling pH for ammonia biofiltration and cucumber yield in a re-circulating aquaponic system with perlite biofilters. HortScience 43: 719-724.
Tyson R V, Simonne E H, Davis M, Lamb E M, White J M, & D D Treadwell (2007) Effect of nutrient solution and pH on nitrification rate in perlite medium. Journal of Plant Nutrition 30: 901-913.

What is claimed:

1. A sustainable Low Water Footprint Re-circulating Aquatic System, comprising:
a) an animal tank;
b) an external pump, wherein the external pump is in fluid communication with the animal tank:
c) a three-stage clarifier system, wherein the three-stage clarifier receives water from the external pump, and wherein the three-stage clarifier separates liquid nitrogenous wastes in the water from solid wastes in the water to form liquid waste water and solid wastes;
d) a plant grow bed, wherein the plant grow bed receives the liquid waste water from the three-stage clarifier system; and
e) a low water footprint management system contained within the plant grow bed, wherein the low water footprint management system filters the liquid waste water and returns it to the animal tank.

2. The sustainable Low Water Footprint Re-circulating Aquatic System of claim 1, further comprising a liquid waste water holding tank, wherein the liquid waste water holding tank is in fluid communication with both the three-phase clarifier and the plant grow bed.

3. The sustainable Low Water Footprint Re-circulating Aquatic System of claim 1, further comprising an overflow, wherein the overflow is in fluid communication with the three-phase clarifier and the plant grow bed.

4. The sustainable Low Water Footprint Re-circulating Aquatic System of claim 1, further comprising a three-way valve manifold, wherein the three-way valve manifold is in fluid communication with the three-phase clarifier and the plant grow bed.

5. The sustainable Low Water Footprint Re-circulating Aquatic System of claim 1, wherein the three-stage clarifier is non-mechanical.

6. The sustainable Low Water Footprint Re-circulating Aquatic System of claim 1, wherein the water management system is a restriction flow water management system.

7. The sustainable Low Water Footprint Re-circulating Aquatic System of claim 1, wherein the plant grow bed further comprises microflora and plants.

8. The sustainable Low Water Footprint Re-circulating Aquatic System of claim 1, wherein the system requires 50% to 80% less water than conventional re-circulating aquatic production systems.

9. A three-stage clarifier system for a re-circulating aquatic system, comprising:
a) a first stage containing a 2 mm mesh filter;
b) a second stage containing a 1 mm mesh filter; and
c) a third stage containing a 25 um mesh filter;
wherein the first stage, second stage, and third stage are arranged such that water can flow from the first stage to the second stage to the third stage.

10. A Low Water Footprint Water Management System for a re-circulating aquatic system, comprising:
a) plastic material having a dome or semi-circular cylindrical shape;
b) a piped access hole situated inside the plastic material, wherein the access hole is capable of delivering water to the system;
c) one or more internal circular openings situated on the internal surface of the plastic material;
d) one or more external circular openings situated on the external surface of the plastic material;
e) pea gravel situated externally to the plastic material; and
f) sand situated on top of the pea gravel and external to the plastic material.
